(19) United States
(12) Patent Application Publication
(10) Pub. No.: US 2007/0272677 A1
(43) Pub. Date: Nov. 29, 2007

(54) SENSOR ELEMENT ARRANGEMENT FOR A CONTROL DEVICE AND METHOD FOR OPERATING SUCH A SENSOR ELEMENT ARRANGEMENT

(76) Inventors: RALF DORWARTH, OBERDERDINGEN (DE); WILFRIED SCHILLING, KRAICHTAL (DE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/752,616

(22) Filed: May 23, 2007

(30) Foreign Application Priority Data
May 23, 2006 (DE) 102006025069.9

(51) Int. Cl. H05B 3/02

(52) U.S. Cl. 219/483

(57) ABSTRACT

A sensor element arrangement beneath a control surface is provided with an electroluminescent foil with a lower electrode and an upper electrode for activating the electroluminescent foil. The upper electrode also serves as a capacitive sensor element in order to detect as a control or operation when a finger is applied to the control surface above the electroluminescent foil or the capacitive sensor element, respectively. For this purpose, a suitable control and evaluating circuit is provided with a control in a full bridge circuit for detecting a sensor current flowing out across the upper electrode and the finger.

### RELATED APPLICATIONS

This application claims priority to German Patent Application No. 10 2006 025 069.9 filed on May 23, 2006, the contents of which are incorporated into this application by explicit reference.

### FIELD OF APPLICATION

The invention relates to a sensor element arrangement for a control device and to a method for operating such a sensor element arrangement.

### BACKGROUND

U.S. 20070068789 A1 discloses a capacitive sensor element placed in the form of a conductive coating under a control surface. Through an appropriate control and evaluation, particularly with a corresponding circuit, it is possible to establish whether there is a control or operation by the application of a finger to the control surface above the sensor element. Thus, between the finger and sensor element a capacitance or capacitor is formed over which flows out a current, or the capacitance of the sensor element is increased.

With the aforementioned sensor element it is admittedly possible to install an electroluminescent or illuminated display under the sensor element and in particular a seven segment display. However, the extra costs for these several separate components is high and this particularly applies to the installation.

### BRIEF DESCRIPTION OF THE DRAWINGS

Embodiments of the invention are described hereinafter relative to the attached diagrammatic drawings, wherein show:

FIG. 1 illustrates one embodiment of the arrangement of an electroluminescent foil, together with the sensor element under a control surface;

FIG. 2 illustrates one embodiment of a control and evaluating circuit for the sensor element and the electroluminescent foil; and

FIG. 3 illustrates one embodiment of a variant of the control and evaluating circuit of FIG. 2.

### DETAILED DESCRIPTION OF THE EMBODIMENTS

The problem of the invention is to provide an aforementioned sensor element arrangement and a method for evaluating a sensor element making it possible to obviate the problems of the prior art and in particular permitting in a very favourable manner the combination of a sensor element and an electroluminescent display.

This problem is solved in one embodiment by a sensor element arrangement having the features of claim 1 and a method having the features of claim 10. Advantageous and preferred developments of the invention are given in the further claims and are explained in greater detail hereinafter. Some features are only mentioned for the arrangement or only for the method, but independently thereof can apply to both of these. By express reference the wording of the claims is made into part of the content of the description.

The conductive coating, which forms the sensor element, is placed as a capacitive sensor element on a support. Said sensor element is then able to detect the approach of a finger of an operator or a similar object. According to the invention the support is constituted by an electroluminescent foil or film, such as are adequately known from the prior art. Such an electroluminescent foil contains for example phosphor for the luminous effect. By applying an electric a.c. field to both sides, particularly via corresponding electrodes, the luminous effect is brought about. Such an electroluminescent display is according to the invention combined as a support with a sensor element, particularly the aforementioned capacitive sensor element.

The conductive coating functioning as the sensor element forms a capacitance or capacitor on the approach of a finger or object, particularly on application to a control surface over the sensor element. A control surface can be a control panel, a housing wall of an electrical appliance or a glass ceramic cooking surface of a hob.

In another embodiment of the invention, the conductive coating is provided on the top of the electroluminescent foil or on the side facing a control surface, such as for example a panel or a housing side or wall. In this way the function as a sensor element is particularly good.

In a further embodiment of the invention, the conductive coating is one of the electrode coatings of the electroluminescent foil and is advantageously an upper coating. To this end it is translucent or transparent and in particular made from ITO. It can be constructed or correspondingly structured for the representation of different characters or symbols, i.e., having the shapes of the characters or symbols. The luminous effect on the electroluminescent foil is then predetermined by the shape of said electrode. On an electroluminescent foil can be provided several sensor elements or conductive coatings, which are juxtaposed or arranged in spaced manner. This offers the advantage that more particularly in the case of a construction as a control device, substantially only a single foil has to be processed or incorporated and on it are located several sensor elements.

At least one electrode or electrode coating of the electroluminescent foil facing the control surface can be connected via switching means to an evaluating circuit. A control takes place by means of a control circuit, particularly on the other electrode or the conductive coating functioning as a sensor element. It is possible for the control circuit and the evaluating circuit to form a combined control and evaluating circuit. In particular, with such a circuit it is possible to operate several similar sensor elements, particularly on the same electroluminescent foil.

According to another embodiment of the invention an evaluating circuit can have a current mirror or a current mirror circuit. This current mirror circuit reflects the current flowing out via the conductive coating and an applied finger into a collecting capacitor, where it is detected as a measure for the outflowing current. On going above or below a threshold value, a control is or is not detected. A possible circuit used for this is described hereinafter.

According to a further embodiment the control and evaluating circuit contains a full bridge circuit for the sensor element or electroluminescent foil. It periodically supplies the conductive coating with a pulsating a.c. voltage, the second branch of the bridge circuit being high impedance-switched. With a suitable circuit, for example according to DE 10303480 A1, it is possible to measure the sensor current. For this purpose, for example in every tenth period of the a.c. voltage the second half of the bridge can be high impedance-switched, the first half of the bridge being operated with a higher frequency. A possible circuit used for this purpose is described hereinafter.

These and further features can be gathered from the claims, description and drawings and the individual features, both singly or in the form of subcombinations, can be implemented in an embodiment of the invention and in other fields and can represent advantageous, independently protectable constructions for which protection is claimed here. The subdivision of the application into individual sections and the subheadings in no way restrict the general validity of the statements made thereunder.

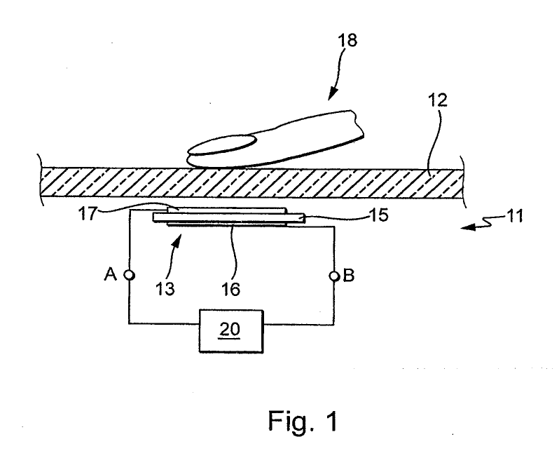

FIG. 1 shows a sensor element arrangement 11. Under a control surface 12, for example a plastic panel or a glass ceramic hob, is provided a module 13 with an electroluminescent foil 15, to whose underside is fitted a lower electrode 16 and to whose top is fitted an upper electrode 17. The electroluminescent foil 15, particularly together with the lower electrode 16, is constructed in conventional manner. The upper electrode 17 also corresponds to a standard construction and is in particular constructed as a transparent, electrically conductive coating, for example of ITO. The shape or surface extension defines in particular the upper electrode 17 with whose geometric shape on the electroluminescent foil 15 a luminous symbol is represented through the transparent control surface 12. Essentially the upper electrode 17 forms the sensor element or the sensor element surface.

Upper electrode 17 is connected across terminal A with the subsequently described circuit 20 and the lower electrode 16 is connected to terminal B. Beneath the control surface 12 could also be provided further such sensor elements, either on the same electroluminescent foil 15 or completely separate therefrom. The electrodes are separated from one another. These further sensor elements are also advantageously connected to circuit 20.

For controlling the electroluminescent foil 15 for display purposes, the latter is operated with a relatively high a.c. voltage of approximately 100 V and a medium frequency, for example between 400 and 2000 Hz. However, as the current which flows out via the finger applied to control surface 12 above the upper electrode 17 is relatively small and within the control via terminals A and B there is only a flow of a total current together with the operating current of the foil, the total current can only be differentiated with difficulty from the current used for emitting light. It must also be borne in mind that the button should in principle operate both in the luminous and in the non-illuminated state.

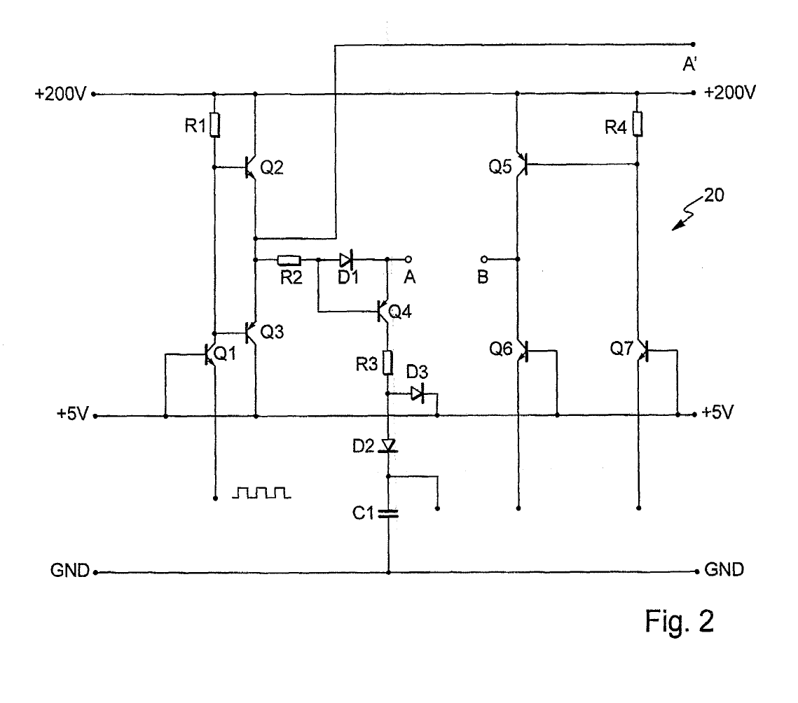

FIG. 2 shows a control and evaluating circuit 20 with which the electroluminescent foil 15 or upper electrode 17 is connected across terminal A and the lower electrode 16 across terminal B. The electrodes are operated in the output branch of a full bridge circuit comprising the first branch with transistors Q2 and Q3 on the one hand and the second branch with transistors Q5 and Q6 on the other. The advantage of this circuit is that the voltage undergoes polarity reversal at electroluminescent foil 15 or electrodes 16 and 17 and consequently an a.c. voltage is applied.

For measuring purposes transistors Q2 and Q3 are for example operated with a frequency of 10 kHz and with a frequency of 1 kHz for emitting light or as an electroluminescent display. Transistors Q5 and Q6 are then switched off for measuring purposes and for emitting light in push-pull mode with a frequency of 1 kHz. Said measurement and light emission is advantageously implemented in alternating manner, so that over and beyond a time period to be detected both functions are exerted in such a way that they can be detected by an operator. Thus, both light emission and detection of an operation or contact must be simultaneously possible, for example if an operator places a finger 18 on the luminous control element for operating purposes.

Thus, if from above finger 18 is placed on the control surface 12 above the sensor element arrangement 1 or upper electrode 17, it forms with said electrode 17 a capacitance and a current can flow out across the operator's finger. If for measurement purposes only the upper electrode 17 is supplied with a pulsating voltage, for example at 10 kHz, the second bridge branch being high impedance-switched and therefore switched off, the sensor current can be determined using a suitable circuit. This determination can take place in that in every tenth period of the a.c. voltage applied to the sensor element or foil 15, the second half of the bridge is high impedance-switched. Instead of this only the first branch is operated with the higher frequency. Thus, the sensor current can be measured in the manner known from U.S. 20060238233 A1, whose contents is hereby incorporated into the present description by express reference. Thus, by appropriate evaluation a contact can be detected, i.e. the case where a current does or does not flow out across upper electrode 17 and finger 18. In a further development of the invention it is conceivable and advantageous to operate the second bridge branch in common mode with 10 kHz.

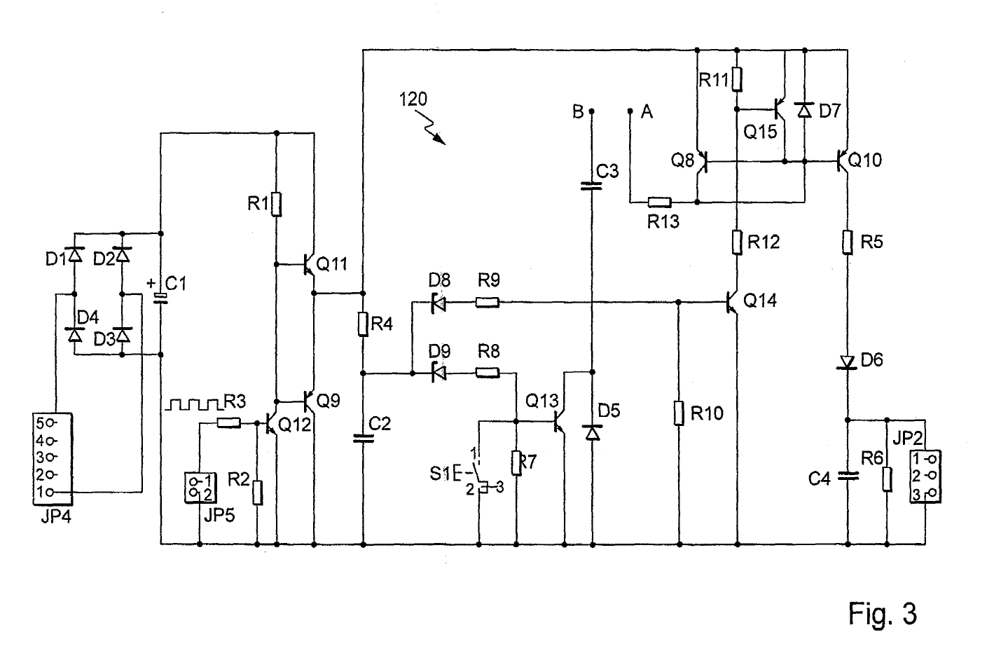

FIG. 3 shows a variant of a control and evaluating circuit 120, in which the lower electrode 16, not selected for capacitive contact, is isolated for a short period, advantageously in each oscillation period of the operating voltage. This time should be dimensioned in such a way that there is complete charging, for example to 100 V, of the sensor current on the capacitor formed by electrode 17 and finger 18. During this time there is only a flow of the sensor current, which is shunted via finger 18 and which can be measured during this time.

The luminous function can be switched on and off via switch S1. A square wave signal with 5 V and 1 kHz can be fed in at resistor R3.

During each positive edge or slope of the operating frequency, across transistor Q13 the control and evaluating circuit 120 applies lower electrode 16 for a few microseconds and with a time lag to the negative pole of the supply voltage. During this time there is only a current flow across the upper electrode 17 and an applied finger 18. If finger 18 is not applied, said current cannot flow.

Transistors Q8 and Q10 form a current mirror via which a roughly equal current flows into capacitor C4. Shortly before the lower electrode 16 is applied to the operating voltage across Q13, transistors Q14 and Q15 switch off the current mirror again, so that the subsequently flowing, higher operating current for the illumination of the electroluminescent foil 15 cannot flow or be reflected in capacitor C4. Thus, in capacitor C4 are collected current pulses which can be used as a measure for the sensor current. Across resistor R6 said current is shunted, so that a voltage is set at R6 as a function of the magnitude of the current. This voltage is a measure for the charge stored in C4 and which is in turn a measure of whether the sensor current can flow across upper electrode 17 and finger 18, i.e., whether finger 18 is applied and consequently a control has or has not taken place. In this case a higher voltage can be detected at R6. If it is above an easily definable threshold value, a control is detected or a control function initiated. If finger 18 is not above the upper electrode 17 on control surface 12, the voltage at R6 is much lower and no control function is initiated.

In one exemplary, but preferred embodiment, a sensor element arrangement is provided beneath a control surface with an electroluminescent foil with a lower electrode and an upper electrode for activating the electroluminescent foil. The upper electrode also serves as a capacitive sensor element in order to detect as a control or operation when a finger is applied to the control surface above the electroluminescent foil or the capacitive sensor element, respectively. For this purpose a suitable control and evaluating circuit is provided with a control in the full bridge circuit for detecting a sensor current flowing out across the upper electrode and the finger via a capacitive coupling.

1. A sensor element arrangement for a control device, said sensor element arrangement having a conductive coating as capacitive sensor element for detecting an approach of an operator's finger or some similar object and having a support for said conductive coating as said capacitive sensor element, wherein said conductive coating is placed on said support and wherein said support is an electroluminescent foil.

2. The sensor element arrangement according to claim 1, wherein a control surface is provided over said electroluminescent foil in parallel orientation and said electroluminescent foil has a topside carrying said conductive coating and is placed such that said topside faces said control surface.

3. The sensor element arrangement according to claim 2, wherein on applying said operator's finger or said similar object to said control surface running over said conductive coating, said conductive coating forms a capacitance or capacitor.

4. The sensor element arrangement according to claim 1, wherein said conductive coating as capacitive sensor element is one of two electrode coatings of said electroluminescent foil for activating said electroluminescent foil, wherein each of said electrode coatings is each affixed to each side of said electroluminescent foil.

5. The sensor element arrangement according to claim 1, wherein said conductive coating is structured in the form of different characters or symbols.

6. The sensor element arrangement according to claim 4, wherein several said capacitive sensor elements are mutually separated conductive coatings juxtaposed on said electroluminescent foil.

7. The sensor element arrangement according to claim 4, wherein said electroluminescent foil has a further conductive coating as an electrode coating placed on an underside of said electroluminescent foil and connected via a switch to an evaluating circuit of said sensor element arrangement.

8. The sensor element arrangement according to claim 4, wherein a control and an evaluating circuit for said capacitive sensor element are provided with a full bridge circuit for polarity reversal of an voltage applied to said electroluminescent foil.

9. The sensor element arrangement according to claim 1, wherein an evaluating circuit is provided to evaluate whether there is an approach of said operator's finger or said similar object, said evaluating circuit having a current mirror circuit and a collecting capacitor for measuring a current flowing out across said capacitive sensor element.

10. A method for evaluating a capacitive sensor element of an sensor element arrangement for a control device, said sensor element arrangement having a conductive coating as capacitive sensor element for detecting an approach of an operator's finger or some similar object and having a support for said capacitive sensor element, wherein said conductive coating is placed on said support, wherein said support is an electroluminescent foil.

11. The method according to claim 10, wherein a current measurement takes place of a sensor current which flows out to ground across said capacitive sensor element or said conductive coating on said approach of said operator's finger or said similar object to said capacitive sensor element.

12. The method according to claim 11, wherein during said current measurement said electroluminescent foil is controlled so as to not emit light.

13. The method according to claim 11, wherein for evaluating said capacitive sensor element, an electrode coating of said electroluminescent foil, which is provided additionally to said capacitive sensor element, is disconnected from a supply voltage and measurement takes place of said sensor current flowing out during this time across said conductive coating and said operator's finger or said similar object being approached to said conductive coating.

14. The method according to claim 11, wherein evaluating said capacitive sensor element takes place with a current mirror circuit and for each positive edge or slope of an operating frequency or operating voltage of said sensor element arrangement, another electrode coating of said electroluminescent foil is applied for a short time and with a time lag to a negative pole of a supply voltage and measurement takes place of said sensor current flowing out during this time across said conductive coating and said operator's finger or said similar object being applied to said conductive coating.

15. The method according to claim 14, wherein said short time is between 1 and 10 microseconds.

16. The method according to claim 14, wherein a current flows across said current mirror circuit and flows into a capacitor for detection purposes, wherein on exceeding a given threshold value of said current a control or operation of said sensor element arrangement is detected and a control function is initiated, wherein on dropping below said threshold control or operation of said sensor element arrangement is denied.

17. The method according to claim 16, wherein said current roughly corresponds to said sensor current flowing out across said conductive coating.

18. The method according to claim 16, wherein a charge from said capacitor is shunted as a current across a resistor and a voltage at said resistor is used as a threshold and monitoring takes place to establish whether said voltage is above or below said threshold.

19. The method according to claim 10, wherein said electroluminescent foil and said conductive coating as an electrode are operated in an output branch of a full bridge circuit.

20. The method according to claim 19, wherein polarity of a voltage at said electroluminescent foil is reversed for applying an a.c. voltage.

21. The method according to claim 20, wherein a pulsating voltage is applied to said conductive coating, another branch of a bridge circuit being high resistance-switched or in common mode, and said sensor current is measured.

22. The method according to claim 20, wherein measurement takes place in that in some periods of said a.c. voltage a second half of said bridge circuit is high impedance-switched or in common mode and said bridge circuit is operated with a higher frequency.
